(19) United States
(12) Patent Application Publication
(10) Pub. No.: US 2025/0040750 A1
(43) Pub. Date: Feb. 6, 2025

(54) BEVERAGE MENU CREATION

(71) Applicant: SOCIETE DES PRODUITS NESTLE S.A., Vevey (CH)

(72) Inventor: SAJAN BALAN, Le Mont-sur-Lausanne (CH)

(21) Appl. No.: 18/717,291

(22) PCT Filed: Dec. 7, 2022
(86) PCT No.: PCT/EP2022/084689

§ 371 Date: Jun. 6, 2024

(30) Foreign Application Priority Data
Dec. 8, 2021 (EP) 21213097.5

(51) Int. Cl. A47J 31/52; B67D 1/00; B67D 1/08; G06F 3/14; G07F 9/00; G07F 13/06

(52) U.S. Cl. CPC A47J 31/521; B67D 1/0041; B67D 1/08; G06F 3/1454; G07F 9/002; G07F 13/06

(57) ABSTRACT

The invention relates to a to a computer-implemented method for displaying automatically on an electronic device the updated beverage menu of a beverage dispensing machine configured to dispense a plurality of beverages. The method comprises steps for transmitting machine and beverage data from a beverage dispensing machine to a remote server and updating a database of the remote server using said machine and beverage data.

### 1. FIELD OF THE INVENTION

The present invention relates to a computer-implemented method for displaying on an electronic device the beverage menu of a beverage dispensing machine configured to dispense a plurality of beverages.

For the purpose of the present description, a “beverage” is meant to include any human-consumable liquid substance, such as tea, coffee, hot or cold chocolate, milk, soup, baby food, etc.

### 2. TECHNICAL BACKGROUND

Many beverage dispensing machines are provided out-of-home in various places like restaurants, canteens, hospitals, train stations, kiosks.

These beverage dispensing machines are set up locally by technical operators. Operators can set parameters related to the price data, temperature settings, brewing times, product type and product location within the machine. If, for example, the product type, or price varies on a regular basis, the operator may need to update the configuration data quite often.

However, generally, the task of the machine operator is not limited to the update of the machine. In beverage dispensing machines, if the beverage menu of the machine must be displayed on an electronic device of a consumer, for example a smartphone, the menu has to be created manually on a remote server platform and linked to the machine. The electronic device can then receive the updated beverage menu from the remote server.

Each menu must be manually created and linked to the corresponding machine on the remote server. Whenever the electronic device of a consumer is enabled to connect to the machine, the electronic device connects to the remote server and downloads the manually created menu that is identical to the menu shown on the machine.

Locally, it is easy for the operator to update the menu on the machine side. However, it takes time to update the menu on the remote server side: the local operator must transmit information to somebody who will update manually the database on the remote server.

This approach creates operational complexity and a risk of human error. Servers are required to set up the remote server and the machine separately whenever there is a new machine installation or a change in the menu of the installed machine, it must be updated two times; one on the machine and one on the remote server.

For example, document WO021981A2 is known in the state of the art, disclosing a system and method of managing product inventories and deliveries of such products. More specifically, WO021928A2 relates to systems and methods of tracking, managing, and accounting for product inventories and/or operability from data extracted directly from remotely located equipment. WO021928A2 discloses an interconnected network to which at least one vending machine is coupled among other devices. These devices may include a handheld circuitry such as a portable digital assistant (PDA), a computing device, a smart card, a network storage device, a server, a network appliance and others. The vending machines can communicate with these devices through the interconnected network. The vending machines transmit data packets to a handheld device or to a server. The servers may manipulate the data packets, store the data packets, add information from the data packets to a database or perform other functions. In the other exemplary embodiment, the vending machine may transfer information such as the data packet to a handheld device. The handheld device may transfer the data packet to a server through the interconnected network. In a further exemplary embodiment, the vending machine may transfer the data packet through the interconnected network in response to a polling signal. The polling signal may be initiated by a handheld device, a cell phone, or a server, among others.

There is no mention of a beverage menu in WO021928A2, the data transmitted from the machine is used for the tracking, managing and accounting of vended merchandise. The vending machine of WO021928A2 requires extra servers such as a service personnel for using the handheld device or requires extra network elements for being able to communicate with the server directly which increases the cost of the manufacture of the machine.

There is a need for a process that would enable the update of the database located on the remote server with the beverages information in an automatic manner without requiring a specific action from the local operator and without adding important costs to the manufacturing of the machine.

Another problem in the beverage dispensing machine industry is that the global pandemic has made most of the consumers hyper-vigilant with hand hygiene leading them to avoid touching things unnecessarily when in public. Most of the beverage dispenser machines comprises a screen comprising plurality of selection buttons enabling the ordering of different beverages. However, the consumer now prefer to order directly from their electronic device connected to the machine.

There is a need for a process that would enable the consumer to order directly from his electronic device, for example a smartphone, instead of touching the screen of the machine for completing the ordering of the beverage.

Therefore, it is an object of the present invention to provide a method which overcome the afore-mentioned drawbacks.

These and other objects which become apparent upon reading the following description, are solved by the subject matter of the independent claim. The dependent claims refer to preferred embodiments of the invention.

### 3. SUMMARY OF THE INVENTION

These aims and other advantages are achieved by a computer-implemented method for displaying on an electronic device the beverage menu of a beverage dispensing machine, said machine being configured for dispensing a plurality of different beverages, the method comprising the steps of transmitting machine and beverage data from the machine to a remote server by a computer program executed on the electronic device, compiling said data into a beverage menu at the remote server; and transmitting the beverage menu compiled at the remote server to the computer program via a communication network and displaying the beverage menu on the electronic device, the remote server stores a database of information relative to a plurality of beverage dispensing machines and the method further comprises the step of updating the database with said machine and beverage data between steps of transmitting machine and beverage data from the machine to a remote server and compiling said data into a beverage menu at the remote server.

Preferably, the beverage menu displayed on the electronic device is a replication of the beverage menu displayed simultaneously on a screen of the beverage dispensing machine.

Preferably, said machine and beverage data comprises at least an identifier of the beverage dispensing machine, and an identifier of each of the different beverages dispensed by the beverage dispensing machine.

Preferably, said machine and beverage data further comprise prices, names, and ingredients of each of the different beverages dispensed by the beverage dispensing machine.

In embodiments, said machine and beverage data are stored in a file of the beverage dispensing machine, said file comprising plurality of lines, each line corresponding to a different type of data represented by a unique identifier.

Preferably, the unique identifier is at the start of the line.

In embodiments, said machine and beverage data are extracted from the file by parsing each of said plurality of lines and retrieving the lines corresponding to at least an identifier of a beverage or an identifier of the beverage dispensing machine using the unique identifiers.

Preferably, the file is formatted with the EVA Data Transfer Standard.

Preferably, the beverage dispensing machine further comprises a control unit for extracting said machine and beverage data from the file.

Preferably, the control unit further comprises a memory unit for storing said machine and beverage data extracted from the file.

Preferably, the communication network between the computer program and the remote server comprises a network interface, wherein the network interface is for example wireless, a Bluetooth™, a near field communication interface, a modem, or a GSM based network.

In embodiments, the step of transmitting said machine and beverage data from the machine to the remote server comprises the following steps: reading a code encoding at least said machine and beverage data presented on the beverage dispensing machine by the computer program executed on the electronic device equipped with a camera or scanner and decoding the code by the computer program and transmitting said code decoded by the computer program to the remote server via the communication network.

Preferably, the code further encodes an Internet address, preferably an URL for connecting to the remote server.

The code may a barcode and/or OID and/or a QR code and/or electromagnetic.

Preferably, the electronic device is a smartphone.

### 4. BRIEF DESCRIPTION OF THE DRAWINGS

FIG. 1 shows the different steps of the method according to the invention;

FIG. 2 shows how the update of the database is done according to the invention.

### 5. DETAILED DESCRIPTION OF EXEMPLARY EMBODIMENTS

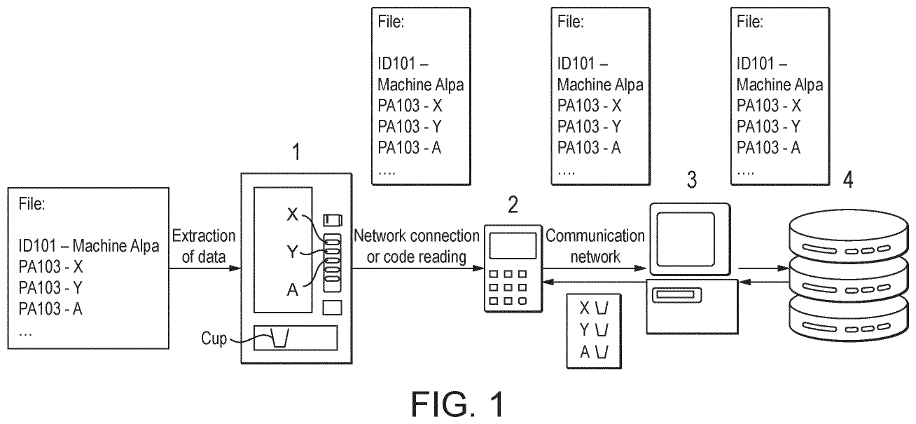

The essential elements of the invention are illustrated in FIG. 1: a beverage dispensing machine 1, an electronic device 2 and a remote server 3 storing a database 4.

As illustrated in FIG. 1, The machine 1 transmits machine and beverage data to the electronic device 2, the electronic device 2 transmits said data to the remote server 3 through a communication network. Consequently, the machine 1 transmits machine and beverage data indirectly to the remote server 3 by the electronic device 2.

The database 4 comprises information relative to a plurality of beverages dispensing machines. The remote server 3 compares and updates the database 4 with said data received from the electronic device 2.

The communication network between the electronic device 2 and the remote server 3 comprises a network interface, the network interface is for example wireless, a Bluetooth™, a near field communication interface, a modem or a GSM based network.

After the update of the database 4, the remote server 3 compiles said data into a beverage menu and transmits the beverage menu to the electronic device 2. The electronic device 2 then displays the beverage menu on its screen.

The beverage menu received by the electronic device 2 is a replication of the beverage menu shown simultaneously on the screen of the beverage dispensing machine 1.

The electronic device 2 is used as an intermediate device which allows the data being transmitted from the beverage dispensing machine 1 to the remote server 3.

Therefore, the electronic device 2 of the consumer or the machine operator acts as a bridge between the beverage dispensing machine 1 and the remote server 3. As a result, the beverage dispensing machine 1 does not need any further element for establishing a direct 20 connection to the remote server 3.

For example, the electronic device 2 may comprise (or can be included in) at least one selected from a group consisting of: a smartphone, a reader that can extract said data from the machine, a laptop computer, a cellular telephone, or a tablet computer.

Said data transmitted from the beverage dispensing machine 1 to the remote server 3 by the electronic device 2 are stored in a file of the beverage dispensing machine 1.

The file comprises plurality of lines. Each line corresponds to a different type of data. Each type of data is represented by a unique identifier. The advantage of using the unique identifiers is that there is no need for to parse all the data contained in the file, the required data can be extracted using the unique identifiers as key elements.

For facilitating the process, the file is preferably formatted with the EVA Data Transfer Standard. The EVA-DTS is an electronic data transfer standard developed by the European Vending Association (EVA).

Nowadays, most of the beverage dispensing machines are EVA-DTS compatible, the machine operator is assured that he can communicate with the machine via a standard interface without the need to purchase different upload and download services for machines made by different manufacturers.

The Standard is based on the concept that data of different types are required to be entered into the machines to enable the machines to deliver the service required. Additionally, data accumulated and stored in the machine are required to be accessed by machine operators and transferred to management systems for either commercial or technical control purposes.

Data segments are composed of a group of a similar function data elements. These elements are not sent individually, but instead are combined into a single line which has a block identifier at the start of the line. The block identifiers of the data segments are equivalents of the unique identifiers discussed above.

In an embodiment, said data comprising beverage and machine related information may comprise at least an identifier of the beverage dispensing machine 1 and an identifier of each of the different beverages dispensed by the beverage dispensing machine 1.

Said data may further comprise prices, names, sales counters, machine events, machine identifier and ingredients of each of the different beverages dispensed by the beverage dispensing machine 1.

As illustrated in FIG. 1, for example, the block identifier “ID101” at the start of the line is followed by a machine identifier. The machine identifier is Machine Alpha. The block identifiers “PA103” at the start of the lines are followed by the beverage identifiers. The beverage identifiers are X and Y. Hence, the file in FIG. 1 represents Machine Alpha with beverages X and Y that can be dispensed.

A control unit of the beverage dispensing machine 1 is configured to extract said data from the file. To do so, the control unit parses the block identifiers of each line (data segment) and filters the required ones, for example all the lines starting with the block identifiers “ID101” and “PA103”. Once said data are extracted and stored in the control unit of the beverage dispensing machine 1, the beverage dispensing machine 1 is ready to transmit said data to the electronic device 2.

A computer program, for example a mobile application, is executed on the electronic device 2 for receiving said data from the control unit and transmitting it to the remote server 3. The transmission is done by a data transmitter means such as Bluetooth, modem or Wi-Fi adapter.

The transmission of said data from the control unit to the computer program is done using a code. The machine 1 presents a code encoding at least said machine and beverage related data.

The computer program reads the code with a camera or scanner of the electronic 2 device to decode it. Said code decoded by the computer program is then transmitted to the remote server 3 via the communication network.

The code may be a barcode and/or OID and/or a QR code, and/or electromagnetic. Usually, the code is printed on a label attached on the dispenser or is drawn on the dispenser. The code may further encode an Internet address, preferably an URL for connecting to the remote server 3 corresponding to the machine 1.

Usually, the code is printed on a label attached on the dispenser or is drawn on the dispenser. The code is preferably positioned on the dispenser in a place that is immediately visible place for a consumer.

Alternatively, a part of said data may be transmitted using a network connection. In this embodiment, said data is divided into two, the first part of said comprises the beverage identifier and the second part of said data comprises the rest of the information. As a first step, the electronic device reads the code for identifying the beverage dispensing machine 1. As a second step, a network connection between the beverage dispensing machine 1 and the electronic device is established and the second part of said data is transmitted via a network unit of the beverage dispensing machine 1 to the electronic device 2.

After the transmission of said data to the remote server 3, the remote server 3 compares said data with the data stored in the database and updates the database with said data for the machine 1.

For comparing said data received from the electronic device 2 and the data stored in the database, the remote server 3 first uses the machine identifier to identify all the data related to the machine 1 in the database. The remote server 3 parses every machine identifier stored in the database until finding the matching one.

After identifying the data of the machine 1 in the database, the remote server 3 compares it with said data. In case there is a difference between these two, the remote server 3 updates the database with said data. Hence, after the update, the database contains the same said data with the machine 1.

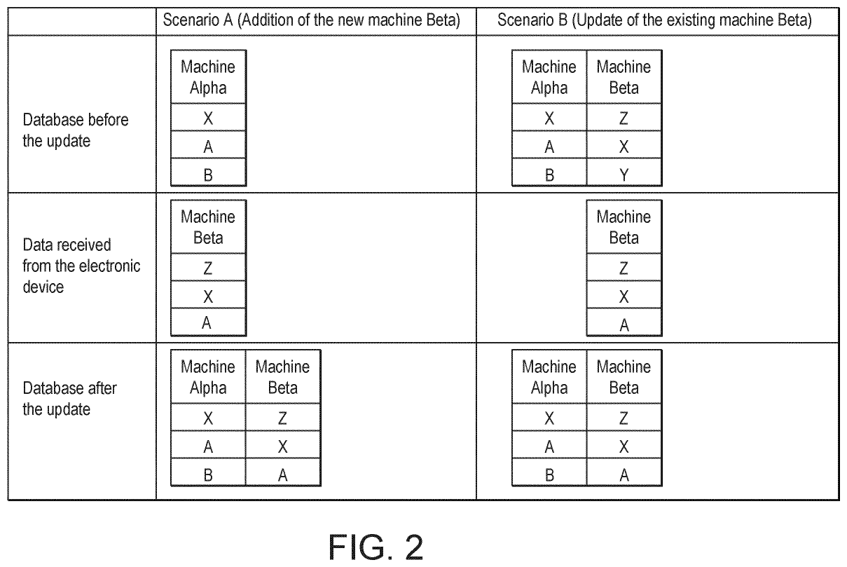

In FIG. 2, an example of the update of the database by the remote server 3 is illustrated. The database contains information linked to a plurality of machines, each represented by an identifier.

In the case of a new machine installation, the database contains no information related to the beverages of the beverage dispensing machine 1 which is illustrated in the first table of FIG. 2. Once said data is received from the electronic device 2, there is no comparison step and said data are automatically saved into the database for machine Alpha.

In another scenario, as illustrated in the second table of FIG. 2, where the database already contains information related to the beverages of the beverage dispensing machine 1, the remote resource 3 first compares said data received from the electronic device 2 and then updates it accordingly.

The FIG. 2 illustrates a simple logic, however it should be clear to the person skilled in the art that the database and said data may contain others elements such as the beverage prices, names for each beverage and ingredients for the preparation of each beverage of the beverage menu.

As a next step, the remote server 3 compiles said data into a beverage menu. Compiling in this context means that the remote server 3 collects and puts together many pieces of information stored in the database.

During the compilation of the beverage menu, there is also a cleaning done by validating data for any error or irrelevant data. The compilation also includes determining the missing values and inputting the most appropriate values in place.

Hence, if said data is not updated correctly in the database 4 for any reason, the computer program can adapt itself and completing the missing values with defaults values stored in the remote server.

Once the beverage menu is compiled and ready to get transmitted, the remote server 3 transmits it to the computer program executed on the electronic device 2 which then displays the beverage menu to the consumer on its screen. Consequently, the consumer sees the most updated beverage menu which is a replication of the menu displayed simultaneously on the screen of the beverage dispensing machine 1.

An advantage of using this method is that whenever there is a change in the menu of the beverage dispensing machine 1, the electronic device 2 of the first consumer using the beverage dispensing machine 1 after the change of the beverage menu will play the intermediate role and transmit said data to the remote server 3 for updating the database 4 stored therein.

The operator of the beverage dispensing machine 1 does not need to take any further action after updating the beverage menu on the beverage dispensing machine 1 as the update will be done automatically by the electronic device 2.

It is enough to have at least one consumer per day to have the database 4 updated at least every day. The work of the local operator is then simplified. If the local operator forgets to update the database 4 of the remote server by using his electronic device 2, the following consumer will do it in his place.

The beverage menu can appear on the screen of the electronic device 2. The instructions may be particularly easy to implement if the electronic device 2 comprises a screen on which instructions in form of photos or films can be showed.

In such a configuration it is no more necessary to manufacture a beverage dispenser machine with an interactive screen for the consumer to input his choice of beverage as the screen of the electronic device 2 can provide the customer with the same information and allow him to order the beverage(s).

In the following paragraphs, the beverage dispensing machine 1 adapted for this method will be explained in more detail.

The beverage dispensing machine 1 is configured for dispensing a plurality of different beverages such as espresso and other coffee beverages, milk beverages, chocolate beverages, tea beverages and soups.

The machine 1 can be an in-home or out of home machine.

The machine 1 may comprise an outlet for dispensing the beverage to a user-receptacle, such as a cup or a mug, located in a receptacle placing area, such as on a receptacle support e.g. an external placement support on which the machine 1 is located or a machine support e.g. a movable or removable machine support, to collect the beverage.

The receptacle may be formed by a support comprised by the machine, e.g. a movable or removable machine support. The receptacle placing area can be associated with a machine recipient support for supporting such user-recipient under the outlet.

The machine 1 comprises a plurality of containers for storing, dosing and dispensing different beverage ingredients. It further comprises at least one beverage preparation unit for preparing a beverage from at least one of the beverage ingredients and a diluent.

The machine 1 comprises at least one beverage preparation unit operatively linked to the containers for preparing a beverage from at least one of the beverage ingredients.

The main utility of the control unit in this invention are explained above; the control unit is configured to extract said data from the file and the data transmitter means transmits said data to the computer program of the electronic device 2.

The control unit is also operable to execute a preparation process comprising controlling said containers and beverage preparation unit(s) to prepare the beverage. The control unit can also control the motors associated to the containers to dose a beverage ingredient amount and dispense said dose in a part of the beverage preparation unit. The control unit can actuate the beverage preparation unit in order to mix the dose of the beverage ingredient with a diluent.

Preferably, the control unit comprises a memory unit for storing said data retrieved from the file. The memory 8 unit typically comprises: a non-volatile memory e.g. EPFROM, EEPROM or FLASH for program code and operating parameter storage; volatile memory (RAM) for data storage. The memory 8 unit may comprise separate and/or integrated (e.g. on a die of the processor) memory.

For transmitting said data from the beverage dispensing machine 1 to the computer program of the electronic device 2 using the code, the beverage dispensing machine 1 further comprises a code processing system for reading the code presented on the beverage dispensing machine 1, decoding the code and transmitting said data in a decoded form to the remote server 3.

The beverage dispensing machine 1 may comprise a network unit for establishing a connection between the electronic device 2. The network unit may be used for receiving commands from the electronic device 2 such as the choice of the beverage to be dispensed.

The beverage dispensing machine 1 may further comprise a screen. As explained in the previous paragraphs, it is not necessary to configure the screen to be interactive for receiving inputs as the electronic device 2 allows the consumer to input his choice of beverage. The inputs of the consumer may then be transmitted from the electronic device 2 to the machine 1 using the communication network.

1. A computer-implemented method for displaying on an electronic device the beverage menu of a beverage dispensing machine, said machine being configured for dispensing a plurality of different beverages, the method comprising the following steps:
a. transmitting machine and beverage data from the beverage dispensing machine to a remote server by a computer program executed on the electronic device;
b. compiling said machine and beverage data into a beverage menu at the remote server; and
c. transmitting the beverage menu compiled at the remote server to the computer program via a communication network and displaying the beverage menu on the electronic device,
wherein the remote server stores a database of information relative to a plurality of beverage dispensing machines and the method comprises the step of updating the database with said machine and beverage data between steps a and b.

2. The method according to claim 1 wherein the beverage menu displayed on the electronic device is a replication of the beverage menu displayed simultaneously on a screen of the beverage dispensing machine.

3. The method according to claim 1 wherein said machine and beverage data comprises at least:
an identifier of the beverage dispensing machine, and
an identifier of each of the different beverages dispensed by the beverage dispensing machine.

4. The method according to claim 3 wherein said machine and beverage data further comprises: prices, names, and ingredients of each of the different beverages dispensed by the beverage dispensing machine.

5. The method according to claim 1 wherein said machine and beverage data are stored in a file of the beverage dispensing machine, said file comprising plurality of lines, each line corresponding to a different type of data represented by a unique identifier.

6. The method according to claim 5 wherein the unique identifier is at the start of each of the plurality of lines.

7. The method according to claim 6 wherein said machine and beverage data are extracted from the file by parsing each of said plurality of lines and retrieving the lines corresponding to at least an identifier of a beverage or an identifier of the beverage dispensing machine using the unique identifiers.

8. The method according to claim 5 wherein the file is formatted with the EVA Data Transfer Standard.

9. The method according to claim 5 wherein the beverage dispensing machine-further comprises a control unit for extracting said machine and beverage data from the file.

10. The method according to claim 9 wherein the control unit further comprises a memory unit for storing said machine and beverage data extracted from the file.

11. The method according to claim 1 wherein the communication network between the computer program and the remote server comprises a network interface for communication, wherein the network interface is for example wireless, a Bluetooth™, a near field communication interface, a modem or a GSM based network.

12. The method according to claim 1 wherein the step of transmitting said machine and beverage data from the machine to the remote server comprises the following steps:
reading a code encoding at least said machine and beverage data presented on the beverage dispensing machine by the computer program executed on the electronic device, said electronic device being equipped with a camera or scanner; and
decoding the code by the computer program and transmitting said code decoded by the computer program to the remote server via the communication network.

13. The method according to claim 12 wherein the code further encodes an Internet address, preferably an URL for connecting to the remote server.

14. The method according to claim 12 or 13 claim 12 wherein the code is selected from the group consisting of a barcode, OID, a QR code, and/or electromagnetic.

15. The method according to claim 1 wherein the electronic device is a smartphone.
